(19) United States
(12) Patent Application Publication
(10) Pub. No.: US 2008/0155622 A1
(43) Pub. Date: Jun. 26, 2008

(54) Service associated with a broadcasting of digital content

(75) Inventors: Ahmad Chami, Rennes (FR); Franck Geslin, Rennes (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/000,908

(22) Filed: Dec. 18, 2007

(30) Foreign Application Priority Data
Dec. 19, 2006 (FR) 06 11068

(51) Int. Cl. H04N 7/173

(52) U.S. Cl. 725/105

(57) ABSTRACT

In a network, which comprises an entity (11) for broadcasting digital contents and a server (10) storing auxiliary data to be associated with at least one digital content, at least one digital content is broadcast to terminals. At least one terminal command is broadcast in this digital content. At the level of a terminal (14) of the network, the digital content broadcast is received (21); said terminal command is extracted (22) from said digital content received; and the terminal command is executed (23, 24) by requesting from said server the auxiliary data associated with the digital content.

The present invention pertains to the management of the broadcasting to terminals of digital contents according to a general broadcasting, such as for example the broadcasting of television programmes.

Various types of telecommunications network make it possible to broadcast digital contents corresponding to programmes of television channels. It is in particular possible to envisage proposing such a broadcasting according to a protocol of DVB type (standing for “Digital Video Broadcasting”).

It is also possible to broadcast such digital contents over networks which are based on protocols of ADSL type, standing for “Asymmetric Digital Subscriber Line”. In this case, television channels can be delivered to subscribers via their telephone line.

With the aim of enriching the broadcasting of these television programmes, it may be advantageous to associate therewith auxiliary data which may for example supplement a sequence of images broadcast with additional information. Such is the case in particular when there is provision to offer terminals the possibility of synchronously displaying subtitles to a sequence of images.

It is also possible to cite as an example of this type, the context of teleshopping, in which provision is made for the terminal of a user to display a conventional sequence of television images of the programme of the teleshopping channel while overlaying thereon auxiliary data associated with this sequence of television images. The auxiliary data may then correspond to a text indicating information pertaining to the objects for sale at that moment on the channel. This text is then displayed overlaid on the images broadcast by the teleshopping television channel. Such auxiliary data may in particular indicate characteristics of the object for sale.

Thus, the information pertaining to the objects for sale is displayed in association with the sequence of television images, since, when another object is for sale on the screen, this information must be modified so as to indicate characteristics pertaining to this new object during presentation.

Such auxiliary information may also offer the user of a terminal a certain level of interactivity. For example, still in the context of teleshopping, auxiliary data associated with a sequence of teleshopping images may allow a user to enter an order to purchase the object during presentation on the screen of his terminal.

By thus associating auxiliary data with a digital content, it is possible to enrich the telecommunication services offered in the broadcasting network considered.

The “Digital Video Broadcasting” (DVB) standard (ETSI TS 102 823 V1.1.1 2005-11) makes it possible to perform in a logically separate manner the transmission of the digital content of the television programme and the transmission of the auxiliary data associated therewith, while making it possible for these two transmissions to be correctly associated over time in such a way that the terminal displays the auxiliary data at the appropriate moment.

According to a standard of this type, the transmission of digital content and the transmission of the associated digital data are multiplexed beforehand.

This type of standard requires a processing which may be complex on reception so as to manage and display these auxiliary data, and therefore demands expensive terminals.

Furthermore, the auxiliary data are then broadcast with the television programme and are therefore transmitted to all the terminals of the broadcasting network. Under such conditions, it is not easy to envisage customizing such auxiliary data per terminal.

It is also complex to manage such auxiliary data in real time, as may be required in the course of managing a multi-player televised game in which the average score changes in the course of time according to the responses given.

Furthermore, within the framework of the use of a broadcasting standard of this type, there exists a strong dependency between the management of the television programme and the provider of an interactive service associated therewith since the inserting of the auxiliary data is carried out at the level of the encoding of the digital content corresponding to the television programme.

The present invention is aimed at improving the situation.

A first aspect of the present invention proposes a method of broadcasting digital contents to terminals in a network comprising an entity for broadcasting digital contents and a server storing auxiliary data to be associated with at least one digital content;

at least one terminal command being broadcast in said digital content;
said method comprising, at the level of a terminal belonging to said network:
/a/ receiving a broadcast digital content;
/b/ extracting said terminal command from said digital content received; and
/c/ executing the terminal command by requesting from said server the auxiliary data associated with the digital content.

By virtue of these provisions, the transmission of the digital content may advantageously be decorrelated from the transmission of the auxiliary data. Specifically, on the one hand the transmission of the digital content is performed by a broadcasting entity which therefore broadcasts the digital content to all the terminals of the network, and on the other hand, the transmission of the auxiliary data is performed from the server.

In such an architecture, the auxiliary data are recovered at the level of the terminal via a point-to-point link which advantageously makes it possible to customize the exchanges between this server and the terminal considered, and thus makes it possible to customize these auxiliary data for each terminal, as appropriate, in a simple manner. Specifically, it is then for example possible to make provision for the server to take account of the identification of the terminal which sent the request for auxiliary data so as to determine the auxiliary data to be dispatched to it. Provision may also be made for the request for auxiliary data that are sent from the terminal to the server to contain parameters, which may have been received in the terminal command broadcast with the television programme. In this case, the server can take account of a combination of these parameters with an identifier of the terminal, so as to determine the auxiliary data which are to be transmitted to this terminal.

By proceeding in this way, the broadcasting of a digital content may be associated with auxiliary data in a flexible manner. Thus, such an architecture makes it possible to broaden the offering of services which may be proposed to users in a customized manner, as appropriate.

Furthermore, in such a context, the terminal may be simpler than in the prior art cited previously since it is no longer responsible for processing the reception of the digital contents multiplexed with the auxiliary data associated therewith. Consequently, the application of such a method may advantageously make it possible to reduce the costs attaching to such terminals. Here, the terminal is simply responsible for receiving and displaying the datastreams pertaining to the digital content broadcast, and extracting terminal commands which are broadcast with these datastreams. Such processing is simple having regard to management of multiplexing of television programmes and auxiliary data and of executing applications which are commanded by the auxiliary data. Within the context of an embodiment of the present invention, the corresponding applications are executed on a server rather than at the terminal level.

Once the terminal command is extracted from the datastream broadcast, the terminal executes it.

In an embodiment of the present invention, the datastream broadcast comprises at least one terminal command whose execution corresponds to the sending of a request for auxiliary data to the server.

The inserting of such terminal commands allows great flexibility in adapting the method to various services that the multiplexed broadcasting of the datastream of the digital content and auxiliary data does not allow.

In such an architecture, it is easy to implement a service in association with a digital content broadcast of the type of a television programme, even if this service corresponds to a plurality of actions either at the terminal level or at the server level.

Specifically, it is advantageously possible to make provision to decompose the implementation of this service into a set of successive elementary actions which are intended to be executed at the level of a terminal of the network and/or at the level of a server of this network.

According to the type of service considered, a more or less fine synchronization is required. Specifically, a service aimed at overlaying subtitles onto a sequence of images requires fine synchronization whereas a service such as alluded to hereinabove in relation to a teleshopping transmission may be implemented on the basis of a more approximate synchronization. The context of the present invention makes it possible to adapt to such differences of demands regarding synchronization. It is possible to provide that the elementary actions arising from the decomposition of the service to be implemented are associated with respective time references which depend on the level of precision of the synchronization required. No limitation attaches to the present invention as to the format of these time references.

No limitation attaches to the present invention in respect of the type of network in which it may be implemented.

In this architecture, it is easy to provide a return voice for interactive services which request responses from users. Specifically, this return voice corresponds to a point-to-point link with the server.

In an embodiment of the present invention, the auxiliary data correspond to an interactive service associated with the digital content broadcast and the execution of each command broadcast in the digital content corresponds to the implementation of a step of said service.

Thus, advantageously the service is decomposed into various steps and the commands are broadcast so as to command the implementation of these steps via the terminal, either at the level of the terminal itself, or else at the level of the server.

The digital content broadcast may furthermore comprise at least one other terminal command corresponding to an execution local to said terminal. Thus, a flexible reception method is obtained.

In an embodiment of the present invention, the digital content and the auxiliary data are associated over time, with a more or less precise synchronization depending on the type of service to be implemented. The terminal and the broadcasting entity are then synchronized with a common time reference and the terminal command broadcast is associated with a timestamp which allows this temporal association between the digital content broadcast and the auxiliary data.

It is also possible to provide that auxiliary data are furthermore received at the level of the terminal in the digital content broadcast. Specifically, it is thus possible to advantageously preserve compatibility with the operation of certain existing networks.

A second aspect of the present invention proposes a method of broadcasting digital contents in a network comprising an entity for broadcasting digital contents and a server storing auxiliary data to be associated with at least one digital content;

in which the broadcasting entity broadcasts a digital content and at least one terminal command in said digital content;
said terminal command commanding a terminal to request from the server said auxiliary data to be associated with the digital content broadcast.

This broadcasting method may furthermore propose the same characteristics as those alluded to hereinabove with regard to the method of reception according to the first aspect of the present invention.

A third aspect of the present invention proposes a terminal adapted for implementing the method according to the first aspect of the present invention.

A fourth aspect of the present invention proposes a broadcasting entity adapted for implementing a method of broadcasting according to the second aspect of the present invention.

A fifth aspect of the present invention proposes a system comprising a terminal according to the third aspect of the present invention and a broadcasting entity according to the fourth aspect of the present invention.

A sixth aspect of the present invention proposes a computer program for a terminal, comprising instructions suitable for implementing the method of reception according to the first aspect of the present invention, during an execution of the program by processing means of the terminal according to the third aspect of the present invention.

A seventh aspect of the present invention proposes a computer program for a broadcasting entity, comprising instructions suitable for implementing the method of broadcasting according to the second aspect of the present invention, during an execution of the program by processing means of the broadcasting entity.

An eighth aspect of the present invention proposes a recording medium readable by a computer on which is recorded the computer program according to the sixth or the seventh aspect of the present invention.

Other aspects, aims and advantages of the invention will become apparent on reading the description of one of its embodiments.

The invention will also be better understood with the aid of the following description of various embodiments of the present invention, with reference to the drawings, in which:

FIG. 1 illustrates a network comprising terminals, a broadcasting entity and a server according to an embodiment of the present invention;

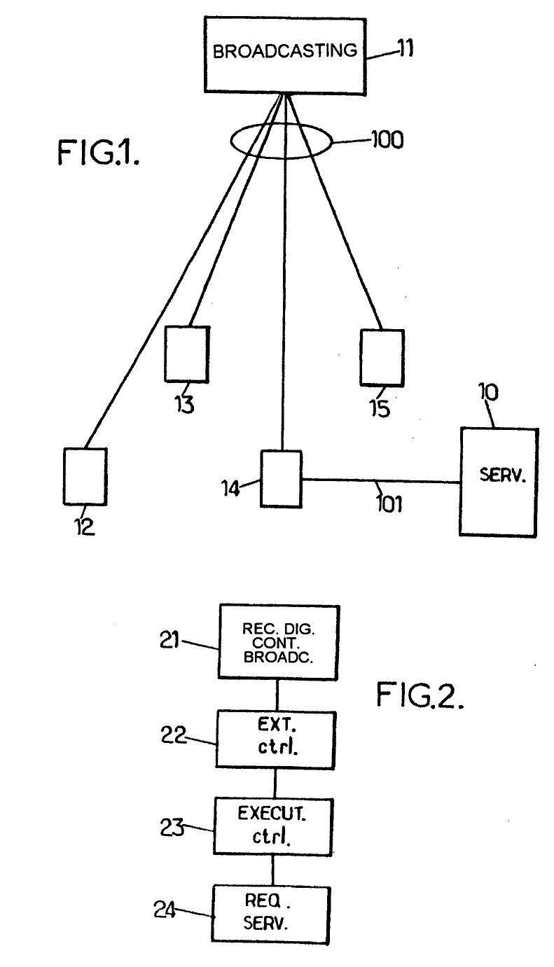

FIG. 2 illustrates the main steps which, in a network such as illustrated in FIG. 1, are implemented at the level of a terminal;

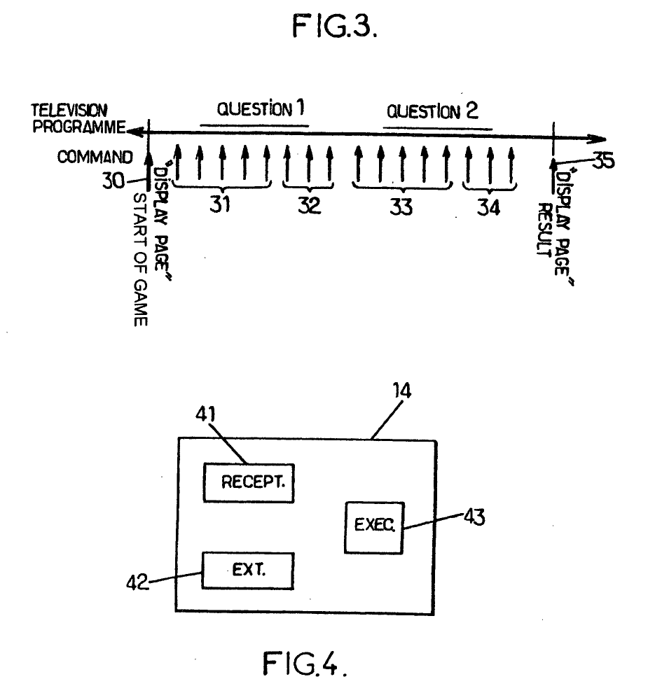

FIG. 3 illustrates a service associated with a television transmission according to an embodiment of the present invention; and

FIG. 4 illustrates an architecture of a terminal according to an embodiment of the present invention.

The present invention is described subsequently in its application to the broadcasting of television programmes by way of example. However, it should be noted that no limitation attaches to the present invention as to the type of data broadcast. Specifically, the present invention may easily be applied if one wishes to associate auxiliary data over time, aimed at supplementing a broadcast datastream.

FIG. 1 illustrates a network according to an embodiment of the present invention. This network comprises a broadcasting entity 11 adapted for broadcasting digital contents 100. In the example considered here, these digital contents correspond to television programmes. In principle, according to general broadcasting, all the terminals 12-15 of the network receive these digital contents.

The network comprises a server 10 adapted for storing auxiliary data and for transmitting them to one of the terminals on request of the latter via a point-to-point link 101.

The terminals may for example be receiver decoder boxes (“set top boxes”).

In the case where just one server 10 is present in the network, it is possible to provide that the terminals of the network know beforehand the access address for this server and that there is therefore no need to transmit this address in the commands inserted into the datastream broadcast.

It is also easy to provide a plurality of servers 10 in such a network. In this case, the commands which are inserted into the datastream broadcast may comprise an indication pertaining to the address to be used to access the server corresponding to this command from among the plurality of servers that the network comprises.

FIG. 2 illustrates the main steps which, in a network as illustrated in FIG. 1, are implemented at the level of the terminal 14 for example.

Thus, in a step 21, the terminal 14 receives a datastream broadcast in the network corresponding to the television programme. Into this datastream is inserted complementary information which corresponds to one or more terminal commands.

Next, in a step 22, the terminal is responsible for extracting the command or commands which are broadcast in the datastream. Thus, in a step 23, the terminal 14 is able to execute the command or commands extracted.

At least one terminal command broadcast in the datastream and received by the terminal 14 corresponds to a request to be sent to the server 10 to recover auxiliary data to be associated with the digital content received in the form of the datastream.

In a step 24, the terminal 14 executes such a command which comprises a step of recovering auxiliary data from the server 10.

The terminal commands included in the datastream broadcast may be of other types. Specifically, they may also correspond to an execution local to the terminal. This is so for example in the context of teleshopping when managing the overlaid display of complementary information. In this case, the terminal 14 displays the images of the television programme as well as auxiliary data, recovered from the server 10, overlaid which correspond to complementary information about the object for sale. Next, in order to halt the displaying of these auxiliary data when the object to which they pertain is no longer on the screen, a new command may be broadcast in the datastream, this new command not requiring a relation with the server and being completely executable locally on the terminal. Provision may also be made for the previous command aimed at recovering the auxiliary data from the server to also indicate the time for which these data are to be displayed. In this case, a broadcasting of a new command to remove the displaying of the auxiliary data is not required, a simple management of timeout locally on the terminal is sufficient.

In a more general manner, terminal commands to which local execution at the terminal level corresponds may relate to the management of the auxiliary data recovered.

A terminal command to be executed locally may also correspond to a change of television channel.

The terminal commands may be relatively basic comprising a step of requesting auxiliary data from a server and a step of managing the displaying of these auxiliary data.

They may also be more sophisticated when, in particular, they are aimed at triggering processing actions on the server 10. Such is the case, for example, when the terminal receives a command corresponding to a recording of the television programme in an automatic manner on a video recorder located on a server of the network.

In an embodiment of the present invention, the broadcasting protocol used in the network is the DVB protocol. This protocol defines the cyclic broadcasting of signalling tables within which a service operator can insert private descriptors, which are freely usable in their content. Provision may thus be made to insert a descriptor “Interaction_Information_Descriptor” such as that defined hereinbelow.

A service to be associated with the digital content broadcast is decomposed into a plurality of elementary actions to which there respectively correspond terminal commands which may be defined and described within one of these private descriptors.

The DVB protocol defines various types of SI tables (standing for “Service Information”), which correspond to different levels of management of broadcasting (“MPEG2/DVB-SI” tables). Thus, certain of these tables are associated with the level of the management of a television channel, such as the tables of SDT types (standing for “Service Description Table”), whereas others are associated with the level of the management of a television transmission, such as the tables of EIT type (standing for “Event Information Table”).

Depending on the service to be implemented in association with a digital content, the terminal commands corresponding to this service may be transported within tables of various types.

When a command relates to a transmission, it is preferably transported in a table of EIT type and when it relates to a television channel, it is preferably transported in a table of SDT type. Each instance of this descriptor “Interaction_Information_Descriptor” describes a command. Thus, when the commands inserted into the stream broadcast relate to a particular television programme, they may be inserted into an EIT table.

In an embodiment of the present invention, such a descriptor has an alterable and changing structure which allows great flexibility and easy adaptation to the implementation of services of a great variety.

A syntax of such a descriptor “Interaction_Information_Descriptor” is presented in the table below.

TABLE 1

| Descriptor_id | This field (8 bits) identifies |
|---|---|
| | the descriptor. |
| Descriptor_length | This field (8 bits) specifies |
| | the number of bytes remaining |
| | in the descriptor. |
| Command_ID | This field (16 bits) gives a |
| | terminal command identifier. |
| Command_type | This field (8 bits) gives the |
| | type of action associated with |
| | the terminal command. Its |
| | structure is that of the |
| | command type table, described |
| | hereinbelow. |
| repetition_code | This field (2 bits) has a |
| | structure described in the |
| | repetition code table, |
| | described hereinbelow. |
| Action_time_code | This field (3 bits) indicates |
| | when to execute an action |
| | associated with a terminal |
| | command. It has a structure |
| | described in the time code |
| | table, described hereinbelow. |
| In_band_data | When this field (1 bit) |
| | indicates the value “1”, |
| | auxiliary data are transmitted |
| | in a datastream broadcast and |
| | when it indicates the value |
| | “0”, the auxiliary data are |
| | obtained through a point-to- |
| | point link. |
| URL_indicator | When this field (1 bit) |
| | indicates the value “1”, a URL |
| | address of a page to be |
| | displayed is provided. This |
| | signifies that the field |
| | url_length exists. |
| parameters_indicator | When this field (1 bit) |
| | indicates the value “1”, the |
| | descriptor contains a loop of |
| | parameters to be dispatched to |
| | the interactive server with the |
| | URL address. |
| When the field | |
| action_time_code | |
| indicates the value | |
| 001 { | |
| component_tag | This field (8 bits) identifies |
| | the elementary stream which |
| | contains a time reference |
| | (“Presentation Time Stamp” or |
| | “PTS”). |
| Pts_action_time | This field (32 bits) indicates |
| | the moment of execution of the |
| | action in the PTS format. The |
| | reference PTS exists in the |
| | elementary stream (or |
| | “Packetized Elementary Stream” |
| | or “PES”) deduced from the |
| | previous field, the field |
| | “component_tag”. |
| } | |
| When the field | |
| action_time_code | |
| indicates the value | |
| 010 { | |
| UTC_action_time | This field (32 bits) represents |
| | the moment of execution of the |
| | action signalled by the |
| | terminal command. |
| } | |
| When the field | |
| In_band_data indicates | |
| the value 1{ | |
| In_band_data ( ) | The structure of this field is |
| | described in the table |
| | in_band_data, set out |
| | hereinbelow. |
| } | |
| When the field | |
| url_indicator indicates | |
| the value 1 { | |
| URL length | This field (8 bits) is present |
| | if the value of the field |
| | url_indicator is set to 1. This |
| | field gives the length of the |
| | URL address in bytes. |
| For (i=0; <N, i++) { | |
| URL_char | This field defines the set of |

bytes constituting the URL
address.

}

| } | |
|---|---|
| When the field | |
| parameters_indicators | |
| indicates 1 { | |
| Parameters_number | This field (8 bits) specifies |
| | the number of parameters |
| | associated with the URL |
| | address. It exists only if the |
| | value of the field |
| | parameters_indicator is set to |
| | 1. |
| for (i=0; <N, i++) { | |
| Parameter_length | This field specifies the length |

of the next parameter.

for (i=0; <N1, i++)
{

| | |
|---|---|
| Param_char | This field (8 bits) defines the |

set of bytes constituting the
parameter.

}

}

| } | |
|---|---|
| selector_byte_length | This field gives the length of |

the next structure
Selector_Byte. The value “0”
indicates that the structure is
not present.

| | |
|---|---|
| for | (i=0; |

| i<selector_byte_length; | |
|---|---|
| i++){ | |
| selector_byte | This field (8 bits) has a |

structure which changes as a
function of the type of action
defined by the field
“Command_type”.

}
}//end

It should be noted that this descriptor advantageously comprises a command identifier in the field “Command-ID” which makes it possible to uniquely identify each command for a given service and the type of command in the field “Command-type” which indicates the type of processing or action associated with each of these commands.

The following table proposes a non-exhaustive list of the actions which may be attached to the terminal commands broadcast, in an embodiment of the present invention.

TABLE 2

| Command_type | Name | explanations |
|---|---|---|
| 0x00 | Null | This command may be used to |
| | | transport the reference |
| | | time when the time of the |
| | | events is expressed as a |
| | | number of clock ticks. |
| 0x01 | Start | This command indicates the |
| | interactivity | start of a service with |
| | | overlaying of information |
| | | onto the images of the |
| | | datastream broadcast. |
| 0x02 | Stop | This command indicates to |
| | interactivity | the terminal that it can |
| | | deactivate the service. |
| 0x03 | display page | This command indicates to |
| | | the terminal that it should |
| | | request a page on a server |
| | | which corresponds to the |
| | | URL address indicated in |
| | | the descriptor. |
| 0x04 | close page | This command indicates to |
| | | the terminal that it should |
| | | close a page already loaded |
| | | from a server. |
| 0x05 | display | This command indicates that |
| | message | auxiliary data which are in |
| | | the datastream broadcast |
| | | should be displayed. |
| 0x06 | close message | This command indicates that |
| | | the displaying of a message |
| | | already loaded from a |
| | | broadcast stream should be |
| | | halted. |
| 0x07 | Start record | This command indicates that |
| | | a recording should be |
| | | triggered. |
| 0x08 | Stop record | This command indicates that |
| | | a recording should be |
| | | stopped. |
| 0x09 | Load page in | This command indicates that |
| | cache | a page should be loaded |
| | | into cache from a server |
| | | according to the URL |
| | | address. |
| 0xA | Identify | This command indicates the |
| | content | identification of a digital |
| | | content or of a |
| | | transmission. |
| 0x0B | Identify | This command indicates an |
| | sequence | identification of a passage |
| | | within a digital content, |
| | | even if the latter is |
| | | already identified, such as |
| | | for example the |
| | | identification of an |
| | | advertising pause in a |
| | | transmission. |
| 0x0C-0xDF | reserved for | These commands are to be |
| | future use | defined. |
| 0xE0-0xFF | user defined | Provision may be made to |
| | | reserve these values for |
| | | private use. |

It should be noted that, through the presence of the “display message” command, there is provision to receive auxiliary data which are received in the datastream broadcast, that is to say which are multiplexed in the datastream as in the prior art described hereinabove.

It may be advantageous to make provision to repeat a command for various reasons, in particular to guarantee receipt thereof by the terminal, or else to dispatch commands in anticipation and to thus prepare the terminal before execution thereof, or else to indicate a period of validity of a command. The repetition of certain of these terminal commands may be managed via a repetition code table, such as that presented hereinbelow:

TABLE 3

| Repetition_code | Meaning |
|---|---|
| 00 | This value corresponds to an |
| | anticipation. Specifically, it |
| | signifies that it is not necessary to |
| | execute the terminal command received |
| | but to prepare for its later execution |
| | (on receipt of one of the other |
| | “repetition_code” codes listed |
| | hereinbelow). |
| 10 | This value indicates that the terminal |
| | command is sent for the first time. In |
| | this case, it is executed. |
| 01 | This value indicates the last sending |
| | of the terminal command. |
| 11 | This value corresponds to a repetition |
| | of the command which must be executed |
| | only if no command with the same |
| | command identifier has been received |
| | and executed before. |

Provision may be made to express a synchronization between the datastreams broadcast and the execution of the terminal commands broadcast according to various formats in an execution timetable (“action_time_code”), such as that presented hereinbelow.

TABLE 4

| Action_time_code | Meaning |
|---|---|
| 000 | This code indicates that there is no |
| | associated time code. Such is the case |
| | for events of digital content |
| | identification type. |
| 001 | This code indicates a time stamp (or |
| | “PTS” for “Presentation Time Stamp”). |
| | The PTS is expressed as a number of |
| | clock ticks. |
| 010 | This code may be used when the |
| | transmission side coder and the |
| | terminal side decoder are synchronized |
| | by GPS (standing for “Global |
| | Positioning System”). |
| 100 | Reserved for future use |
| 101 | Reserved for future use |
| 110 | Reserved for future use |
| 111 | This code is used to command immediate |
| | execution of the terminal command. |

The structure of the field In_band_data exists if the value of the field In_band_data is set to 1. This structure may be such as that presented in the table below:

TABLE 5

| In_band_data { | |
|---|---|
| If_ip_address { | This field (1 bit) makes it |
| | possible to specify whether the |
| | auxiliary data are broadcast in an |
| | IP stream over a broadband network. |
| Reserved | Reserved (7 bits) |
| IP address | This field (32 bits) specifies an |
| | IPv4 unicast/multicast/broadcast |
| | address. |
| Port_number | This field (8 bits) provides the |
| | port number associated with the IP |
| | address. |
| } | |
| Original_network_id | This field (16 bits) identifies the |
| | original network. |
| Transport_stream_id | This field (16 bits) identifies the |
| | transport stream number. |
| Service_id | This field (16 bits) makes it |
| | possible to identify the service |
| | transported in the data. |
| Component_tag | This field (8 bits) corresponds to |
| | an identifier of the transport of |
| | the service used in the datastream. |
| } | |

Such a descriptor makes it possible to implement a method according to the present invention by decomposing the service to be associated with the datastream broadcast into a plurality of terminal commands with which are associated the moments of execution of these commands in relation with the sequence of images corresponding to the datastream broadcast.

In the following sections, such a method of broadcasting is described in its application to a service such as an interactive game of quiz type in which a television viewer can play at the same time as the guests who are in the television studio.

An invitation message to participate in the game is displayed according to an embodiment of the present invention. The viewers having responded to this invitation are advised of the start and end of each question and are invited to respond to these questions.

FIG. 3 illustrates the commands which are broadcast in the datastream corresponding to the broadcasting of a transmission of such a game.

A descriptor “Interaction_Information_Descriptor” is inserted into the EIT table relating to the television transmission in question. This descriptor comprises a command of “display page” type 31 for question 1 and 32 for question 2. In this embodiment, in order to guarantee receipt of the command, the latter is broadcast several times.

At the terminal level, the execution of the command of “display page” type 30 consists in requesting a page on a server, this page corresponding to the home page of the game being broadcast. The URL address which makes it possible to connect to the corresponding server is provided also in the descriptor.

In the course of the progress of the game, a new descriptor “Interaction_Information_Descriptor” is inserted at the start of each question so as to command the displaying of the corresponding page, and another one is inserted at the end of each question to command the closing of the corresponding page. The terminal requests the page relating to each question according to the URL address provided in the corresponding descriptor.

The command of “close page” type 35 signalled by the descriptors at the end of the questions makes it possible to close the page relating to the question considered and to thus stop the possibility of responding to the questions. At the end of the game, the URL address dispatched in the end descriptor relates to the page which displays the results obtained by the user.

On the basis of this example, it is easy to deduce diverse applications of an embodiment of the present invention.

FIG. 4 illustrates an architecture of a terminal 14 according to an embodiment of the present invention.

Such a terminal comprises a reception unit 41 adapted for receiving a digital content broadcast, an extraction unit 42 adapted for extracting this terminal command from the digital content received, and an execution unit 43 adapted for executing the terminal command by requesting from the server the auxiliary data associated with the digital content.

1. Method of receiving digital contents at the level of a terminal of a user (14) in a network comprising an entity (11) for broadcasting digital contents and a server (10) storing auxiliary data to be associated with at least one digital content;
at least one terminal command being broadcast in said digital content;
said method comprising the following steps, at the level of said terminal:
/a/ receiving (21) a broadcast digital content;
/b/ extracting (22) said terminal command from said digital content received; and
/c/ executing (23, 24) the terminal command by requesting from said server the auxiliary data associated with the digital content;
the auxiliary data corresponding to an interactive service, which requests responses from the user through a return pathway to the server and which is associated with a digital content broadcast.

2. Method of receiving digital contents according to claim 1, furthermore comprising the following step, after step /c/:
/d/ emitting a response from the user to said server.

3. Method of receiving digital contents according to claim 1 or 2, in which the interactive service is decomposed into various steps, and in which the execution of each command broadcast in the digital content corresponds to the implementation of a step of said interactive service.

4. Method of broadcasting digital contents in a network comprising an entity (11) for broadcasting digital contents and a server (10) storing auxiliary data to be associated with at least one digital content;
in which the broadcasting entity broadcasts a digital content and at least one terminal command in said digital content;
said terminal command commanding a terminal of a user to request from the server said auxiliary data to be associated with the digital content broadcast;
the auxiliary data corresponding to an interactive service which requests responses from the user through a return pathway to the server, and which is associated with the digital content broadcast.

5. Method of broadcasting according to claim 4, in which the broadcast digital content furthermore comprises at least one other terminal command corresponding to an execution local to said terminal.

6. Method of broadcasting according to claim 4 or 5, in which the terminal and the broadcasting entity are synchronized to a common time reference and in which the terminal command broadcast is associated with a time stamp which allows a temporal association between the digital content broadcast and the auxiliary data.

7. Method of broadcasting according to claim 4, in which auxiliary data are furthermore broadcast in the digital content broadcast.

8. Terminal (14) of a user in a network comprising an
entity (11) for broadcasting digital contents and a server (10) storing auxiliary data to be associated with at least one digital content;
at least one terminal command being broadcast in said digital content;
said terminal comprising
a reception unit (41) adapted for received a digital content broadcast;
an extraction unit (42) adapted for extracting said terminal command from said digital content received; and
an execution unit (43) adapted for executing the terminal command by requesting from said server the auxiliary data associated with the digital content;
the auxiliary data corresponding to an interactive service which requests responses from the user through a return pathway to the server and which is associated with the digital content broadcast.

9. Entity (11) for broadcasting to terminals (12-15)
of respective users digital contents in a network furthermore comprising a server storing auxiliary data to be associated with at least one digital content;
said broadcasting entity being adapted for broadcasting to terminals (12-15) a digital content and at least one terminal command in said digital content;
said terminal command commanding a terminal to request from the server said auxiliary data to be associated with the digital content broadcast;
the auxiliary data corresponding to an interactive service which requests responses from the user through a return pathway to the server and which is associated with the digital content broadcast.

10. System for broadcasting digital contents comprising terminals (12-15) according to claim 8 and a broadcasting entity (11) according to claim 9.

11. Server in a network furthermore comprising an entity (11) for broadcasting digital contents and a terminal (14) of a user;
said server (10) storing auxiliary data to be associated with at least one digital content broadcast by said broadcasting entity and being adapted for:
receiving, from the terminal, a request for the auxiliary data to be associated with a digital content received by the terminal; and
transmitting said auxiliary data requested to said terminal;
the auxiliary data corresponding to an interactive service which requests responses from the user through a return pathway to the server and which is associated with the digital content broadcast.

12. Computer program for a terminal (14) of a user, comprising instructions suitable for implementing the method of reception according to any one of claims 1 to 3, during an execution of the program by processing means of the terminal.

13. Computer program for a broadcasting entity (11), comprising instructions suitable for implementing the method of broadcasting according to claim 4, during an execution of the program by processing means of the broadcasting entity.
